(19) United States
(12) Patent Application Publication
(10) Pub. No.: US 2011/0066478 A1
(43) Pub. Date: Mar. 17, 2011

(54) ADVERTISING DISPLAY CONTROL SYSTEM

(75) Inventor: Jose Machado Marin, Barcelona (ES)

(73) Assignee: Industex, S.L., Barcelona (ES)

(21) Appl. No.: 12/882,535

(22) Filed: Sep. 15, 2010

Related U.S. Application Data
(60) Provisional application No. 61/242,446, filed on Sep. 15, 2009.

(51) Int. Cl. G06Q 30/00; G06F 17/30

(52) U.S. Cl. 705/14.4; 707/769; 707/E17.014; 707/705

(57) ABSTRACT

An advertising display control system includes a display stand on which merchandise is displayed. An audio-visual (AV) component on which a prerecorded promotional video of the merchandise is playable for viewing by consumers passing by the display stand. A controller is provided that monitors the state of the AV component, such as, whether it is powered on or off or whether there is no power to the system. A General Packet Radio Service (GPRS) module communicates the detected state of the AV component to a database. A user interface enables a remote user to access the database to monitor the detected state of the AV component. The GPRS module may also communicate video or photos of the displayed merchandise to the database to permit the user to remotely visually monitor the display stand.

### BACKGROUND

Product display stands, such as stand-alone kiosks, aisle end caps or other display stands are often used in retail stores to feature certain products or to promote a special sale on a product. It is well established that display stands located in high traffic areas will have greater sales than in areas where fewer shoppers pass. Thus, display areas located near the store entrance or near check-out aisles or at the ends of aisles are often vigorously pursued by sales representatives and distributors of consumer products.

Presenting a product in an appealing manner is an important driver of sales volume. For example, it is well established that if the display stand runs out of product or is otherwise in disarray, sales volume will decrease. Thus, it is important to monitor the display stand to ensure that it is neat, orderly and is well stocked with product so that the product is presented in the most appealing manner to consumers.

Utilization of audio-visual (“AV”) components into display stands to drive sales by playing infomercials or videos to shoppers passing buy is becoming increasingly more popular. This increase in popularity is due to advent of thin flat screen televisions and compact portable media, such as CD's, DVD's and SD cards, which are now much more portable and take up less space their predecessors, and because they have become relatively inexpensive. It is well established that incorporating AV components which visually and audibly convey product features, advantages and uses of a product to shoppers passing by will result in increased sales of that product. It is also well established that if a display stand incorporating AV components is not properly maintained to ensure that the AV components are operating and functioning properly, sales volume of the product will fall. Thus, with AV incorporated display stands, it is not only important that the display stand remains neat, orderly and well stocked with product, it is important that the AV components incorporated into the display stand are operating properly and continuously during store hours.

Monitoring and maintaining product displays in stores is typically the responsibility of the product vendor. Historically, this required the vendor to have sales representatives visit the retail store at least once, if not several times a week, to restock the display with product, to ensure that the display is neat and to ensure that all AV components are operating properly. This task can become overwhelming when it is necessary to monitor multiple product displays located in multiple stores in multiple locations.

While one method of remotely monitoring product displays may be possible by using the Internet and a Webcam, most store owners will not permit vendors to access or utilize the store's wired or wireless local area network (LAN) to communicate the Webcam images over the Internet because of potential security issues, nor will most stores allow a vendor to install its own Internet connection to facilitate use of the Webcam to monitor the product display over the Internet. In any event, the cost of installing a separate Internet connection through an Internet Service Provider (“ISP”) at multiple stores would be cost prohibitive even if permitted by the store owner. Accordingly, it is desirable to provide a means of remotely monitoring a product display that does not require the use of the store's LAN, does not interfere with or disrupt the store's existing LAN or Internet connection, does not require a separate Internet connection or the services of an ISP to facilitate data transmission for the remote monitoring, and which is low in cost to install, use and maintain.

### DESCRIPTION OF THE DRAWINGS

FIG. 1 is a schematic illustration of one embodiment of an advertising display control (ADC) system for monitoring a product display.

FIG. 2 is a schematic illustration of the ADC system of FIG. 1, for monitoring multiple product displays in multiple locations.

FIGS. 3 and 4 are front and rear perspective views, respectively, showing an embodiment of the ADC system of FIG. 1 showing the product display stand.

FIG. 5 is a perspective view of one embodiment of the controller for the ADC system of FIG. 1.

FIG. 6 is a front side elevation view of the controller of FIG. 5.

FIG. 7 is a bottom plan view of the controller of FIG. 5 illustrating one position for the moveable mounting plate.

FIG. 8 is another bottom plan view of the controller of FIG. 5 illustrating another position of the movable mounting plate.

FIG. 9 is a schematic block diagram of the components of the controller of FIG. 5.

FIG. 10 is a schematic diagram of an embodiment of the state detector for the controller of FIG. 5.

FIGS. 11A-11F are electrical schematics of the various preferred components for the controller of FIG. 5.

FIG. 12 is an example of an embodiment of a screen for the Web-based user interface of the ADC system of FIG. 1.

FIG. 13 is an example of an embodiment of another screen for the web-based user interface of the ADC system of FIG. 1.

### DESCRIPTION

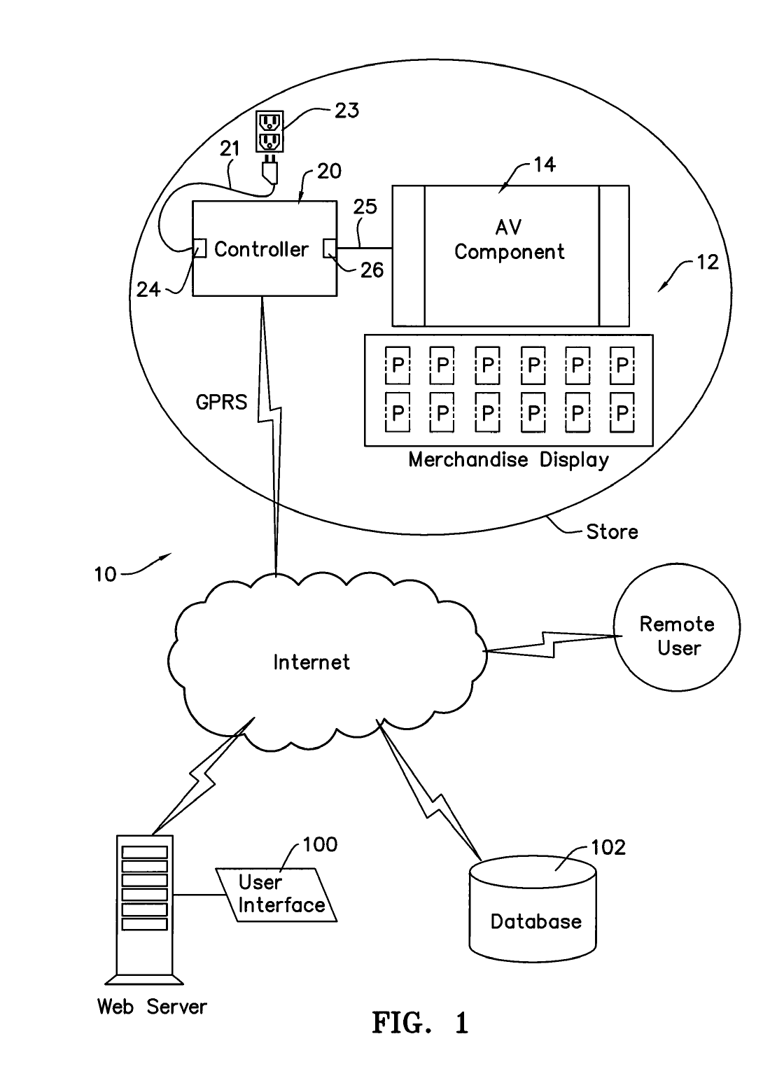

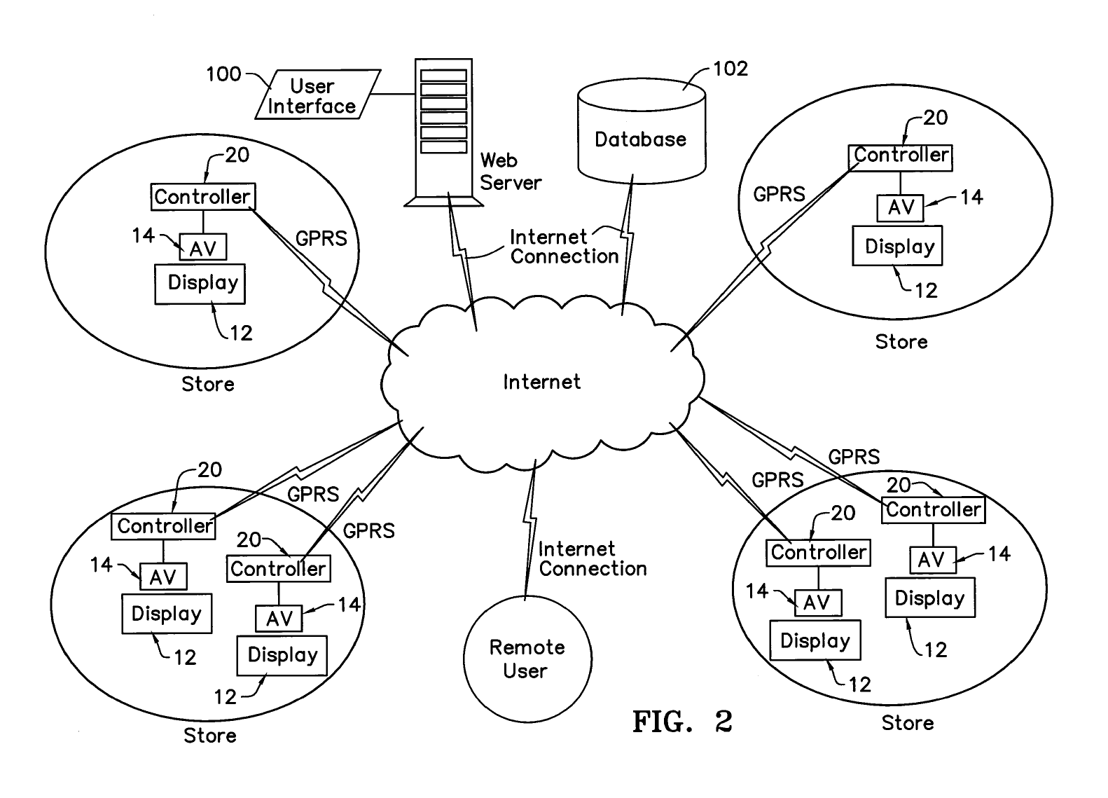

Referring now to the drawings, wherein like reference numerals designate identical or corresponding parts throughout the several views, FIG. 1 schematically illustrates an embodiment of the Advertising Display Control (“ADC”) system designated generally by reference numeral 10. Continuing to refer to FIG. 1 along with FIGS. 2-4, the ADC system 10 includes a controller 20 located at or near a display stand 12 used to display merchandise or products “P” being offered for sale. The display stand 12 includes an audio-visual (“AV”) component or components 14 on which a pre-recorded promotional video of the product P is being played to consumers as they pass by the display stand 12. As used herein, the term “AV component” should be understood to include any component or combination of components capable of displaying and playing recorded video and audio, such as, for example a television and a DVD player. As used herein, the term “merchandise” or “product” should be understood to include any good or service that may be offered for sale or for licensing, rental, leasing to a consumer, prospective purchaser or user of the good or service.

In a preferred embodiment, the ADC system 10 utilizes a General Packet Radio Service (GPRS) module (discussed later) as a relatively low cost means to communicate the detected state (i.e., on, off, no power) of the AV component 14 and visual images of the display stand 12 to a database 102 while avoiding the need for an Internet connection through an Internet Service Provider (ISP) to facilitate the data communication from the controller 20 located in the store to the database 102. The ADC system 10 preferably utilizes a World-Wide-Web (“Web”) based user interface 100 to allow a user to monitor the status of the AV component 14 and, preferably, to visually inspect the display stand 12 from any remote location via the Internet. The user interface 100 is preferably hosted on a Web server connected to the Internet by any suitable Internet connection. As illustrated in FIG. 2, it is contemplated that a typical ADC system 10 will enable a user to monitor multiple display stands 12 at different locations within a single store or in multiple stores.

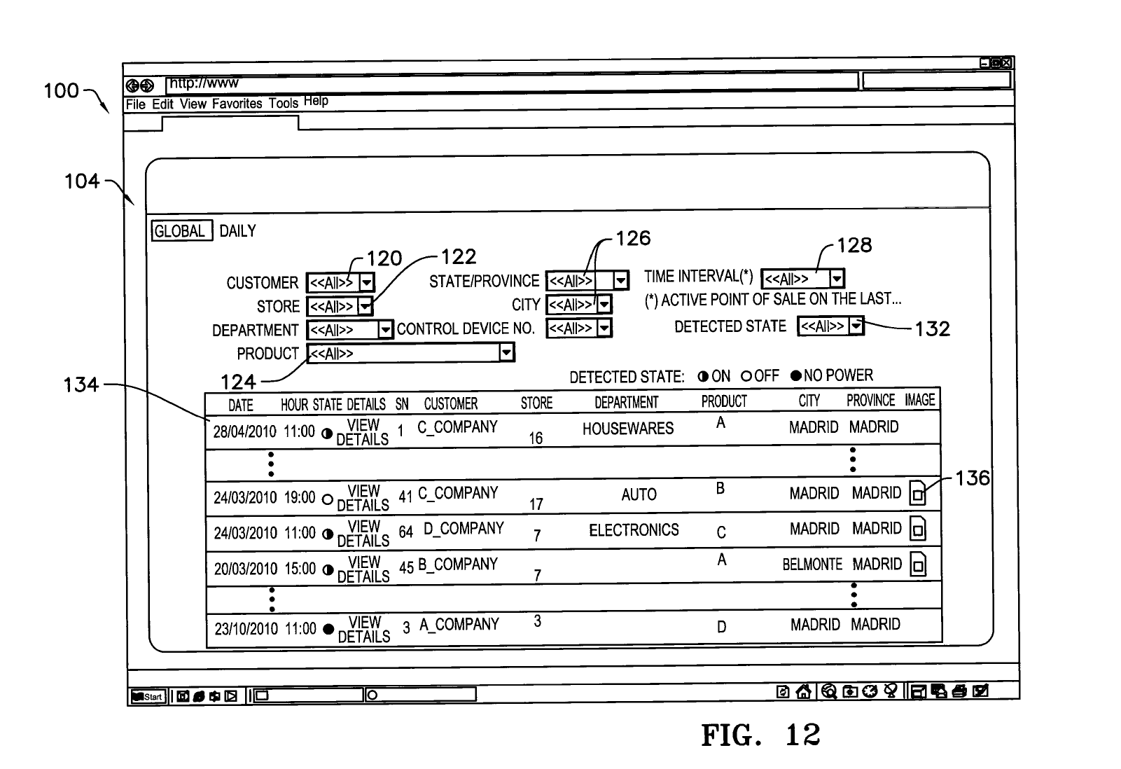

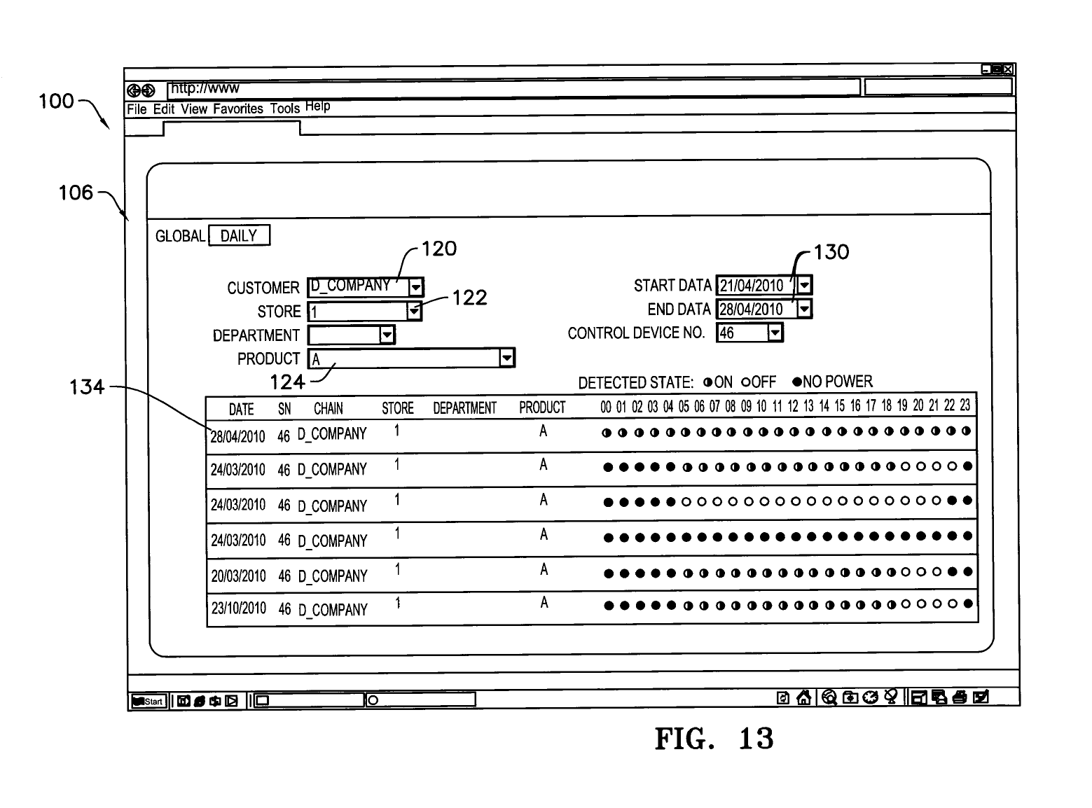

As used herein, the term “database” should be understood to include or refer to any software or computer implemented system that permits the storage, management and retrieval of data. The database 102 may reside on the Web server hosting the user interface 100 or it may reside on any other computer server. In any event the database 102 is preferably connected to the Internet via any suitable Internet connection. The database 102 preferably includes numerous fields by which a user can search the database to retrieve desired data by entering or selecting search criteria, such as the search criteria identifiable in FIGS. 12 and 13 discussed later.

Although specific reference is made throughout this specification to the “Internet,” such term should be understood to include any type of network infrastructure now existing or later developed. Similarly, although specific reference is made throughout this specification to the “World-Wide-Web” or “Web,” such terms should be understood to include any type of data sharing model now existing or later developed for sharing data over the Internet or other network infrastructure.

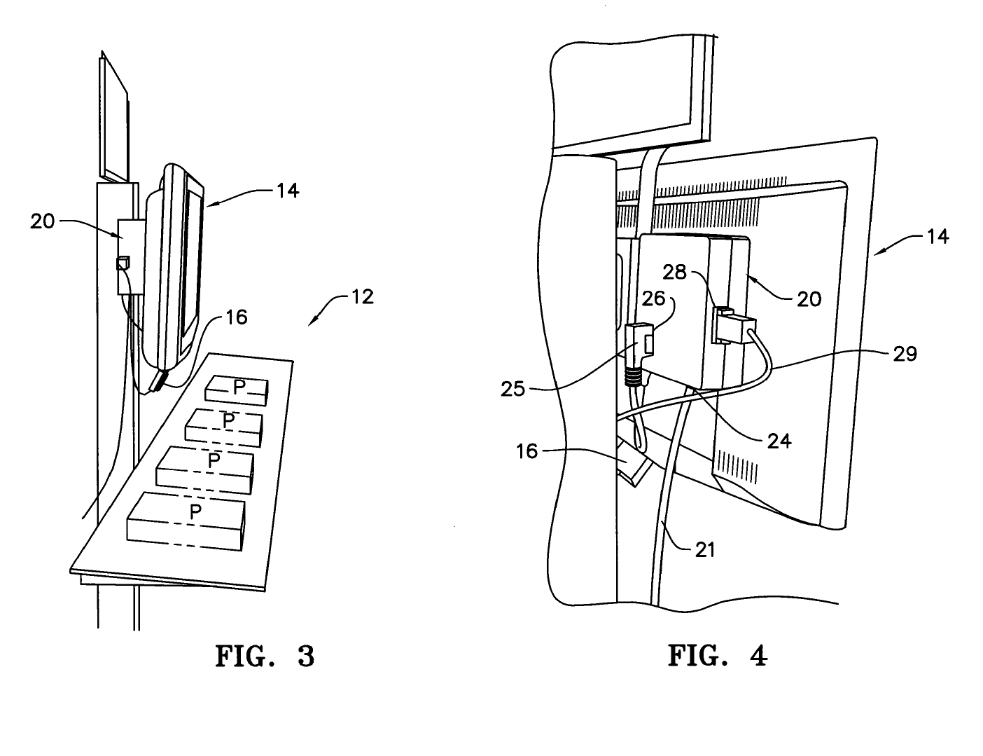

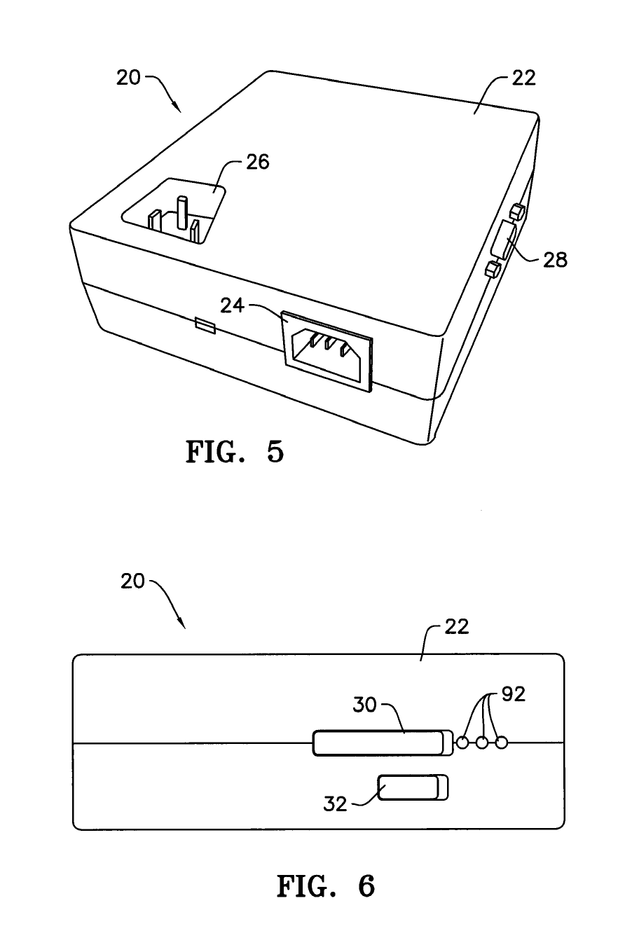

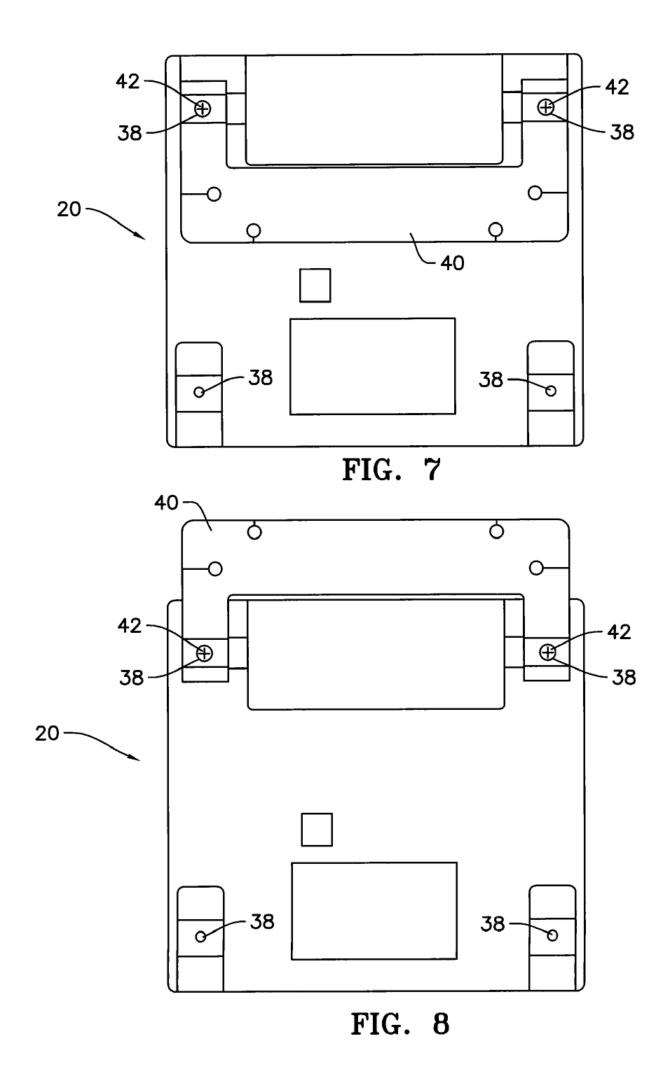

A preferred embodiment of the exterior of the controller 20 is shown in FIGS. 3-8. The controller 20 preferably includes a housing 22 (FIGS. 5-6) with a Power-In port 24, a Power-Out port 26, a camera port 28, a Secure Digital (“SD”) memory card port 30, and at least one universal serial bus (“USB”) port 32. The purpose of each of these components and other components comprising the controller 20 will be discussed later.

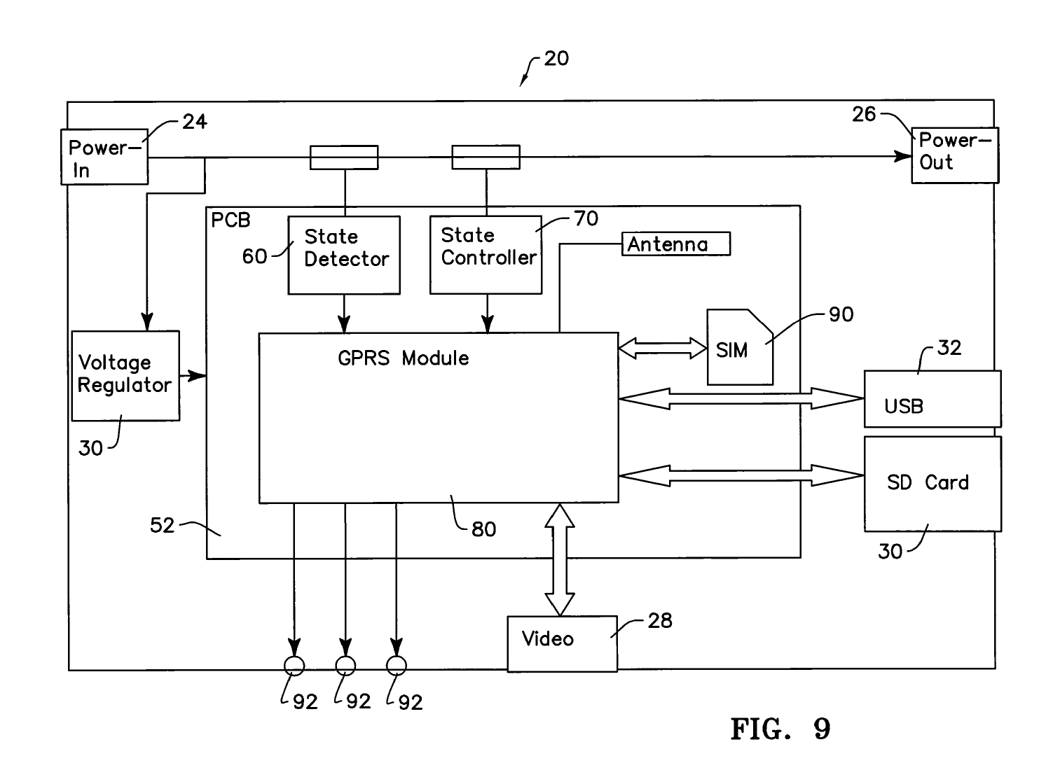

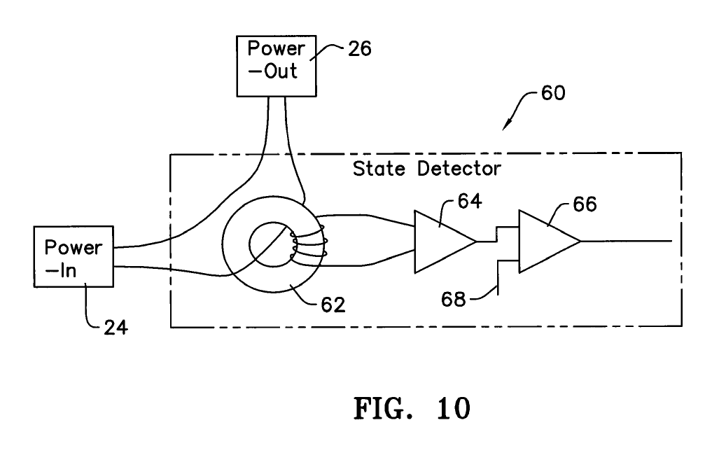

Referring to FIGS. 7 and 8, the bottom of the housing 22 preferably includes a plurality of apertures 38 and a removable mounting bracket 40 secured by screws 42. It should be appreciated that the mounting bracket 40 is capable of being removed and reattached to the housing 22 by the screws 42 in different orientations (compare FIGS. 7 and 8, for example) so as to permit different mounting options for securing the controller 20 to the support structure of the display 12 or other structure.

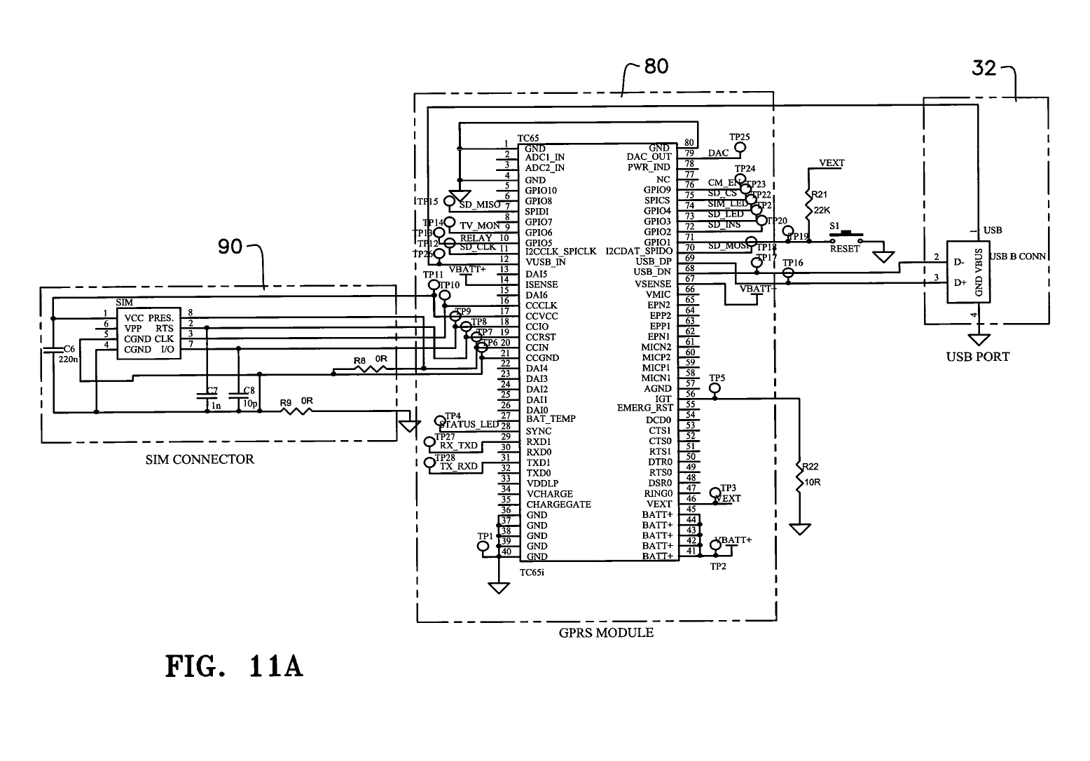

Referring to FIG. 9, a schematic block diagram of a preferred embodiment of the controller 20 is illustrated. Power is supplied to the controller 20 via a power cord 21 (see also FIGS. 1, 4). One end of the power cord 21 plugs into the store's conventional power outlet 23 (FIG. 1) and the other end plugs into the controller's Power-In port 24 (FIGS. 4, 5, 9). The Power-In port 24 is electrically coupled to the controller's Power-Out port 26 (see also FIGS. 4, 5) which is adapted to receive the AV component's power cord 25 (FIGS. 1, 4). A voltage regulator 50 is electrically coupled with the Power-In port 24 to provide the appropriate voltage to the printed circuit board (PCB) 52.

The various electrical components which provide the desired functionality of the controller 20 are preferably electrically coupled to the PCB, including, for example, the state detector 60, the state controller 70, the GPRS module 80, the SIM card 90, light indicators 92, etc., each of which is discussed in greater detail below.

State detector 60 is electrically coupled between the Power-In port 24 and Power-Out port 26 to detect whether power is being supplied to the controller 20 and to detect electrical current flow as a means of detecting whether the AV components 14 are powered on or off. In a preferred embodiment a state controller 70 is also preferably provided to permit the power to the AV components 14 to be remotely controlled by the user.

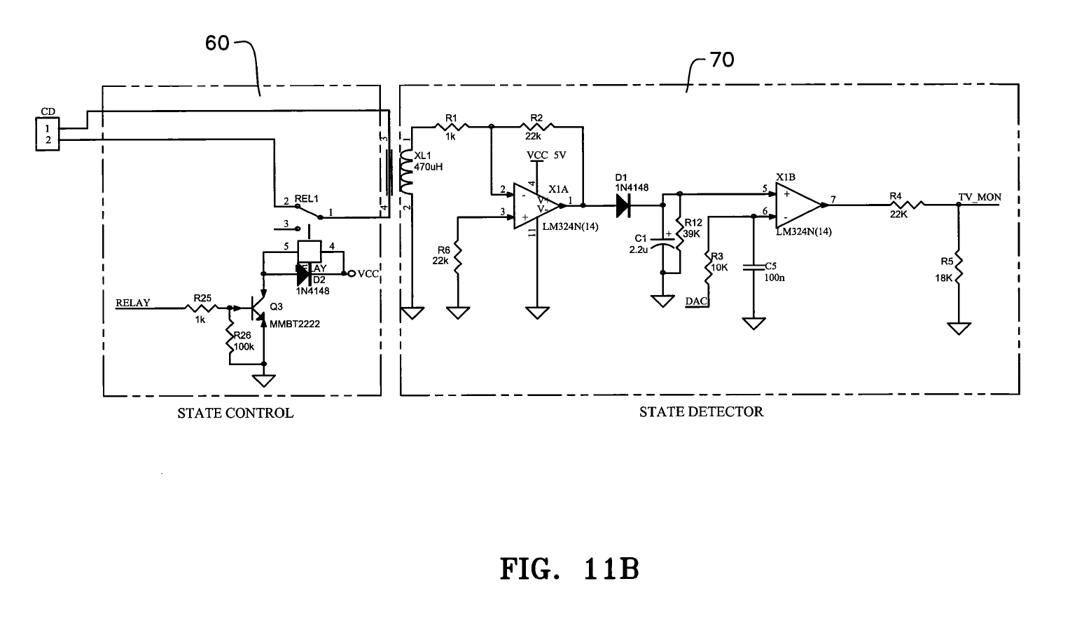

FIG. 10 is a schematic illustration of a preferred embodiment of the state detector 60. The state detector 60 includes a coil 62 through which passes either the hot or neutral wire 63 extending between the power inlet 24 and power outlet 26. As current passes through the wire 63 a corresponding signal is generated by the coil 62. Amplifier 64 (such as an LM324) amplifies the signal. The amplified signal is compared by comparator 66 with a predefined current reference input 68 corresponding to the “on” state of the AV component 14. If the amplified signal meets or exceeds the predefined current reference, an output signal is generated by the comparator 66 corresponding to an “on” state for the AV component 14. If the amplified signal does not meet the predefined current reference, an output signal is generated by the comparator 66 corresponding to an “off” state for the AV component 14. If no signal is generated by the coil 64 due to no current flowing through the wire 63, a “no power” state output signal is generated by the comparator 66. These “on”, “off” and “no power” signals are delivered to the GPRS module (discussed later) for communication to the database 102.

The preferred GPRS module 80 (such as a Cinterion TC65i) cooperates with the Subscriber Identity Module (“SIM”) card 90 which is provided by a wireless GSM (Global System for Mobile communications) carrier, such as AT&T, T-mobile, etc. The GSM carrier provides the data communication services between the controller 20 and the database 102. The GPRS module, along with any other necessary circuitry as recognized by those of ordinary skill in the art, is preferably programmed to perform the state detection (i.e., “on”, “off”, “no power” states) and to upload those detected states to the database 102 at predefined or definable time intervals.

The USB port 32 provides a data connection for programming and configuring the controller 20 prior to installation and/or for updating the controller. The SD Card port 30 receives SD Cards used to update the controller 20 as desired to add new features or functionalities to the system and it may be used for calibrating the state detector 60 as needed for different types of AV Components 14.

Indicator lights 92 provide visual indication that the controller 20 is powered on and communicating with the database 102 via the GRSM module 80.

The camera port 28 receives the video cable 29 (FIG. 4) connected to the camera 16 used for monitoring the display 12. The camera port 28 may be a VGA port (shown in FIG. 5) or any other type of video connection port, including IEEE 1394, USB, etc.).

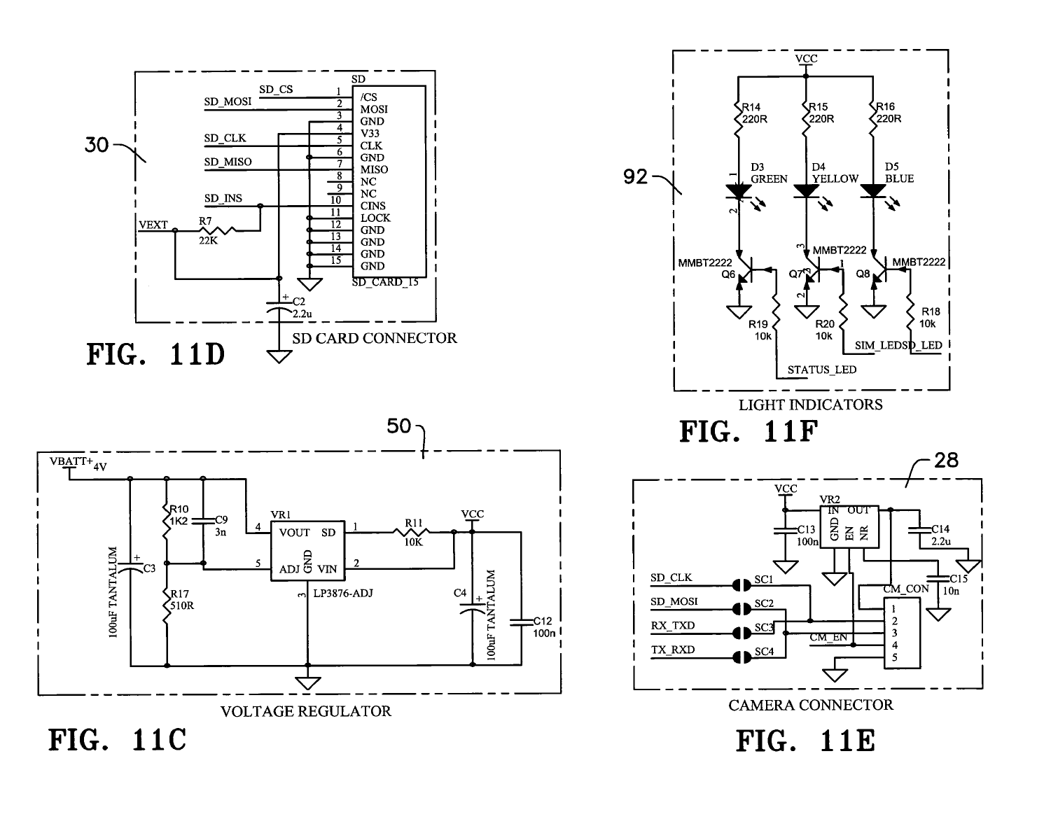

FIGS. 11A-11F are electrical schematics of the various preferred components comprising the preferred controller 20. Specifically, FIG. 11A is an electrical schematic showing the preferred GPRS module 80, SIM connector 90 and USB port 32. FIG. 11B is an electrical schematic of the preferred state control 60 and state detector 70. FIG. 11C is an electrical schematic of a preferred voltage regulator 50. FIG. 11D is an electrical schematic of the preferred SD Card connector 30. FIG. 11E is an electrical schematic of the preferred camera connector 28. FIG. 11F is an electrical schematic of the preferred light indicators 92.

In use, the controller 20 is preferably mounted behind the AV component 14 so that it is preferably hidden from view (FIGS. 3-4). The AV component 14 with the controller 20 mounted thereto are preferably secured to the display stand 12 or some other structure. A power cord 21 (FIG. 1) is plugged into the Power-In port 24 of the controller 20. The other end of the power cord 21 is plugged into the store's power outlet 23. The power cord 25 of the AV component 14 is plugged into the Power-Out port 26 of the controller 20. A camera 16 is preferably mounted to preferably view and capture as much of the display stand 12 as possible so a user can remotely visually inspect the display stand 12 to ensure it is adequately stocked with product P and that the AV component 14 is operating properly. Output signals of the state detector 60 are communicated to the GPRS module 80 which then transmits the detected state output signals and captured camera images to the database 102 via GPRS. The captured camera images may be video images or photographic images.

A remote user preferably accesses the user interface 100 over the Internet via a Web browser, such as Internet Explorer, Firefox, etc., to monitor the data, including the captured camera images, transmitted via GPRS to the database 102. The preferred user interface 100 preferably allows a user to choose between a “Global” template or screen 104 (FIG. 12) and a “Daily” template or screen 106 (FIG. 13). Within each template 104, 106 are preferably are number of predefined selectable criteria corresponding to searchable fields of the database 102. For example, the selectable criteria may include one or more drop-down listings that allows the user to search by customer 120, store 122, product 124, and location 126 (such as city, state or province) among or other criteria. The template also preferably allows the user to select desired time intervals or periods 128 and date ranges 130 (only in Daily template FIG. 13) for displaying the retrieved data. The user interface 100 also preferably allows the user to select the desired “Detected State” 132 to retrieve (i.e., “on”, “off”, “no power”). For example, a user may only want to retrieve search results in which AV components 14 have detected states of “off” or “no power.” Below the selectable criteria drop downs, the templates 104 and 106 include a window 134 in which the data corresponding to the selected search criteria is displayed. As illustrated, in FIG. 12, each of the drop-down search criterias in the template preferably has a default of “all” such that the search query will retrieve and display a listing of all the data associated with a particular user, preferably organized by date. Also as shown in FIG. 12, the preferred user interface 100 preferably identifies whether images are available of the particular display stand 12 by an image icon 136. The user interface 100 preferably allows the user to view the captured images by selecting the image icon 136 with a mouse or other pointing device. Upon selecting the image icon 136, the user interface 100 preferably opens up a separate window on the screen (not shown) to display the captured image.

FIG. 13 illustrates a preferred “Daily” template 106 displaying results of a query in which a user, for example, chose display results based on the following criteria for the respective drop-down listings: store 122=“1”, customer 120=“D-Company”, and product 124=“A”. The example also shows that the user selected a date range 130 between April 21 and Apr. 28, 2010. The results based on the search criteria are displayed in the results window 134. In the example of FIG. 13, the results window 134 shows the various detected states (on/off/no power) of the AV components 14 reported in hourly increments over a twenty four hour period. Other time intervals are also preferably definable and selectable.

It should be appreciated that the user interface 100 preferably includes a log-on screen (not shown) wherein the user is required to enter a username and password or other unique identifier to be able to gain access to the database 102. Once assigned, this unique identifier is then used to associate particular data to that user so as to prevent other users from accessing and retrieving data to which they are not associated and authorized to view. It should also be appreciated that the user interface may include other templates which allow a user to add or input data into the database or to edit previous entries in database.

The foregoing description is presented to enable one of ordinary skill in the art to make and use a preferred embodiment of the invention. Various modifications to the preferred embodiment, and the general principles and features described herein will be readily apparent to those of skill in the art. Thus, the present invention is not to be limited to the embodiments described above and illustrated in the drawing figures, but is to be accorded the widest scope consistent with the spirit and scope of the appended claims.

1. An advertising display control (ADC) system, comprising:
a display stand on which merchandise is displayed;
an audio-visual (AV) component on which a prerecorded promotional video of the merchandise is playable for viewing by consumers passing by the display stand;
a database;
a controller electrically disposed between an electric power source and the AV component and capable of detecting a state of the AV component;
a GPRS module communicating the detected state of the AV component to the database; and
a user interface through which a remote user is capable of accessing the database to monitor the detected state of the AV component.

2. The ADC system of claim 1 further including a camera disposed to capture images of at least a portion of the displayed merchandise; said GPRS module communicating said captured images to said database; and wherein the user interface allows the remote user to access and view the captured images.

3. The ADC system of claim 1 wherein the detected state of the AV component includes an “on” state.

4. The ADC system of claim 1 wherein the detected state of the AV component includes an “off” state.

5. The ADC system of claim 1 wherein the detected state of the AV component includes a “no power” state.

6. The ADC system of claim 1 wherein the user interface is capable of displaying the detected state of the AV component over a time period.

7. The ADC system of claim 1 wherein the user interface is capable of displaying the detected state of the AV component over a time period and date range.

8. The ADC system of claim 7 wherein the user interface is capable of querying the database by criteria selected from the group comprising: merchandise, location, store, time interval, and date range.

9. An advertising display control (ADC) system, comprising:
a) a database; and
b) a plurality of display stands, each of which is disposed at a different location and each of which displays different merchandise, each of said plurality of display stands comprising:
i) an audio-visual (AV) component on which a prerecorded promotional video of the merchandise on display at the display stand at the location is playable for viewing by consumers passing by;
ii) a controller electrically disposed between a power source and the AV component and capable of detecting a state of the AV component;
iii) a GPRS module communicating the detected state of the AV component to the database;
c) a user interface through which a user is capable of accessing and querying the database to monitor the detected state of the AV component at each of the plurality of display stands.

10. The ADC system of claim 7 wherein each of the display stands further includes a camera disposed to capture images of at least a portion of the displayed merchandise; said GPRS module communicating said captured images to said database; and wherein the user interface allows the remote user to access and view the captured images.

11. The ADC system of claim 9 wherein the plurality of display stands are within a single store.

12. The ADC system of claim 9 wherein the plurality of display stands are in different stores.

13. The ADC system of claim 9 wherein the detected state of the AV component includes an “on” state.

14. The ADC system of claim 9 wherein the detected state of the AV component includes an “off” state.

15. The ADC system of claim 9 wherein the detected state of the AV component includes a “no power” state.

16. The ADC system of claim 9 wherein the user is capable of querying the database by selecting merchandise.

17. The ADC system of claim 9 wherein the user is capable of querying the database by location.

18. The ADC system of claim 12 wherein the user is capable of querying the database by store.

19. The ADC system of claim 9 wherein the user is capable of querying the database by detected state of the AV component.

20. The ADC system of claim 9 wherein the user is capable of querying the database by detected state of the AV component over a date range.

21. The ADC system of claim 9 wherein the user is capable of querying the database by criteria selected from the group comprising: merchandise, location, store, time period, and date range.
